(19) United States
(12) Patent Application Publication
(10) Pub. No.: US 2004/0081413 A1
(43) Pub. Date: Apr. 29, 2004

(54) High fiber density hybrid cable

(76) Inventors: Luis M. Bocanegra, Alpharetta, GA (US); Harold P. Debban, Snellville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/281,812

(22) Filed: Oct. 28, 2002

(51) Int. Cl. G02B 6/44

(52) U.S. Cl. 385/114

(57) ABSTRACT

A hybrid optical fiber cable for bearing trunk traffic as well as local traffic has at least one tubular sheath member containing a fiber ribbon stack and surrounded by a sheath member and one or more smaller tubular sheath members within the surrounding sheath member in a configuration amenable to breaking out one or more fibers for local traffic without disturbing the fiber ribbon stack or stacks.

### FIELD OF THE INVENTION

The present invention pertains to the field of high fiber density optical fiber cables.

### BACKGROUND OF THE INVENTION

The optical communications field is growing at a rapid rate, requiring continuing advances in the development of the numerous components required in optical communications as well as continuing improvements in existing components. It is anticipated that in the near future, optical fibers will replace metallic conductors substantially completely in communication signal transmission. One genus of optical fiber components is the transmission means used to transmit signals to their ultimate destination. Usually, for long distance or trunk usage, cables are required which have a large fiber capacity, while for local use, only a few fibers encased in a suitable means, i.e., stranded cable or small fiber ribbons, are required.

It is common in the prior art to form ribbon cables for use in loop or trunk arrangements. An optical fiber ribbon is usually formed as a planar array of closely adjacent parallel fibers embedded in a suitable supporting medium, to form a ribbon having, for example, twelve parallel fibers. A cable is formed by stacking a number of ribbons together, such as twelve ribbons, to create a structure that contains, for example, one hundred and forty-four fibers. The ribbon stack is, generally, enclosed in a loose sheath or tube, which most often is filled with a suitable water blocking filling compound. Additional protective sheath and strength members may surround the tubular sheath containing the stack, the core tube. In U.S. Pat. No. 4,744,631 of Eichenbaum, et al, the disclosure of which is incorporated herein by reference, there is shown such a cable wherein the filling compound is a thixotropic material having a low yield stress. A high density cable can have one or more stacks of, for example, twelve ribbons per stack, with each ribbon having twelve fibers. Thus, a cable stack has, for example, one hundred and forty-four (144) fibers. In U.S. Pat. No. 5,857,051 of Travieso, et al., the disclosure of which is incorporated herein by reference, there are shown cables with several ribbon stacks, each enclosed in its own sheath, and the several sheaths enclosed in an outer sheath or jacket.

In the wiring of premiums, such as, for example, an office building, such a high density cable of stacks can be used, with individual ribbons and individual fibers being broken out for use at individual stations within the building. However, the breaking out operation in such a stack containing cables is tedious and subject to error. Where such cables are used to supply individual residences, for example, the break out operation can entail the breaking out of only one or two individual fibers from the entire collection of stacks, which, again, is tedious and subject to error. Obviously, cables containing stacked ribbons are better suited for long hand or trunk transmission, where, at each destination, large numbers of fibers are to be broken out.

In local use situations, where there are numerous stations, e.g., customer premises, it is common practice to use loose tube cabling, where a plurality of fibers (such as twelve) are loosely contained within a tubular sheath which, usually, is filled with a suitable water-proofing compound, and accurate break-out of individual fibers is relatively easy. Loose tube cabling is not generally amenable to long distance or trunk usage, such as a stacked ribbon cable, but, on the other hand, is to be preferred where local usage requires a large number of break-outs.

In urban areas, high cable density is a desideratum that is difficult to attain where trunk operation and local operation are both required.

### SUMMARY OF THE INVENTION

The present invention is a hybrid cable for combining trunk or long haul transmission with local area transmission which utilizes both a stacked ribbon configuration and a piggy-back loose tube configuration, wherein both types of transmission are optimally realized, and, for a given cable diameter, the fiber density is greater than heretofore realized in the prior art.

In a first preferred embodiment of the invention, the cable has a central member having a plurality of stacked fiber ribbon such as, for example, twelve ribbons bearing one hundred forty-four fibers, encased in a sheath which, preferably, has a waterproofing material, such as a gel therein. Immediately surrounding the sheath are a plurality, such as twelve, loose tube cables, each containing twelve fibers in a loose tube configuration. The assembly is surrounded by a jacket which may comprise a protective sheath of, for example, high density polyethylene having strength members embedded therein, a polyester tape, and a second protective sheath having strength members embedded therein. The strength members may be steel wire, fiber glass roving, aramid fiber or yarn, or other suitable strength providing material. It is to be understood that the jacket may comprise other layers, or only one layer, than those shown herein. The cable of the embodiment has a central tubular member of a first diameter and a plurality of surrounding tubes of a second lesser diameter, and contains two hundred and eighty-eight (288) fibers. The cable core central tube diameter contains a twelve fiber ribbon stack and therefore normally contains one hundred and forty-four fibers. The twelve smaller diameter outer tubes contain a total of one hundred and forty-four (144) fibers, there being twelve loose fibers in each tube, and thus a fiber density increase of forty-eight fibers is achieved in approximately the same diametric dimension as a prior art two stack cable, and one-hundred and forty-four of the fibers contained in the smaller diameter tubes are readily accessible for breaking out.

The embodiment of the invention achieves the aim of both long haul and short haul in a single fiber cable that is approximately equal in outside diameter to prior art cables, and which is of a higher fiber density than prior art cables of the same size.

In a second embodiment of the invention, the structure is the same as in the first embodiment except that each of the smaller tubes contains a fiber ribbon stack of twelve fibers, for example, or a single twelve fiber ribbon.

In a third embodiment of the invention, three ribbon fiber stacks are contained in three sheaths of a first diameter within an outer jacket. As will be seen hereinafter, in such an arrangement, where connection of the centers of the three sheaths forms a triangle, having at least three interstices into which can be fitted three fiber units of lesser diameter, each having approximately thirty-six fibers. Normally, to realize this many fibers in a small tubular member would preferably require the use of fiber ribbons stacked together, where the ribbons each contain, for example, six fibers. It is also possible to have the fibers loose in the tubes, as in the first embodiment. In this embodiment, the cable core has five hundred and forty (540) fibers in the same diameter cable as a prior art cable having four hundred and thirty-two (432) fibers, and gives a twenty-five percent (25%) increase in fiber density.

In still another embodiment of the invention, the cable has four fiber ribbon stack units containing five hundred and seventy-six (576) fibers and five twenty-four fiber tubes of lesser diameter than the stack units for a total of six hundred and ninety-six (696) fibers contained within a cable jacket having the same diameter as a prior art five hundred and seventy-six (576) fibers cables, a twenty-one percent (21%) increase in fiber density in the same diameter cable as a prior art five hundred and seventy-six fiber cable. In both of these last two embodiments, the smaller tubes may have a loose tube fiber configuration or a ribbon stack configuration. In either case, break-out is much simpler than with the one hundred forty-four fiber stacks in the larger diameter units.

Each of the foregoing embodiments is a high density hybrid cable having one or more large tubes containing stacked fiber ribbons, which serve as a trunk cable, and a plurality of small tubes of loose tube or smaller ribbon stack configuration which function as local area cables.

The features and principles of the present invention will be more readily apparent from the following detailed description read in conjunction with the drawings.

### DESCRIPTION OF THE DRAWINGS

FIG. 1 is a cross-sectional elevation view of a cable embodying the principles of the invention;

FIG. 2 is a cross-sectional elevation view of a variation for use in the cables of the invention;

FIG. 3 is a cross-sectional elevation view of another cable embodying the principles of the invention; and

FIG. 4 is a cross-sectional elevation view of still another cable embodying the principles of the present invention.

### DETAILED DESCRIPTION

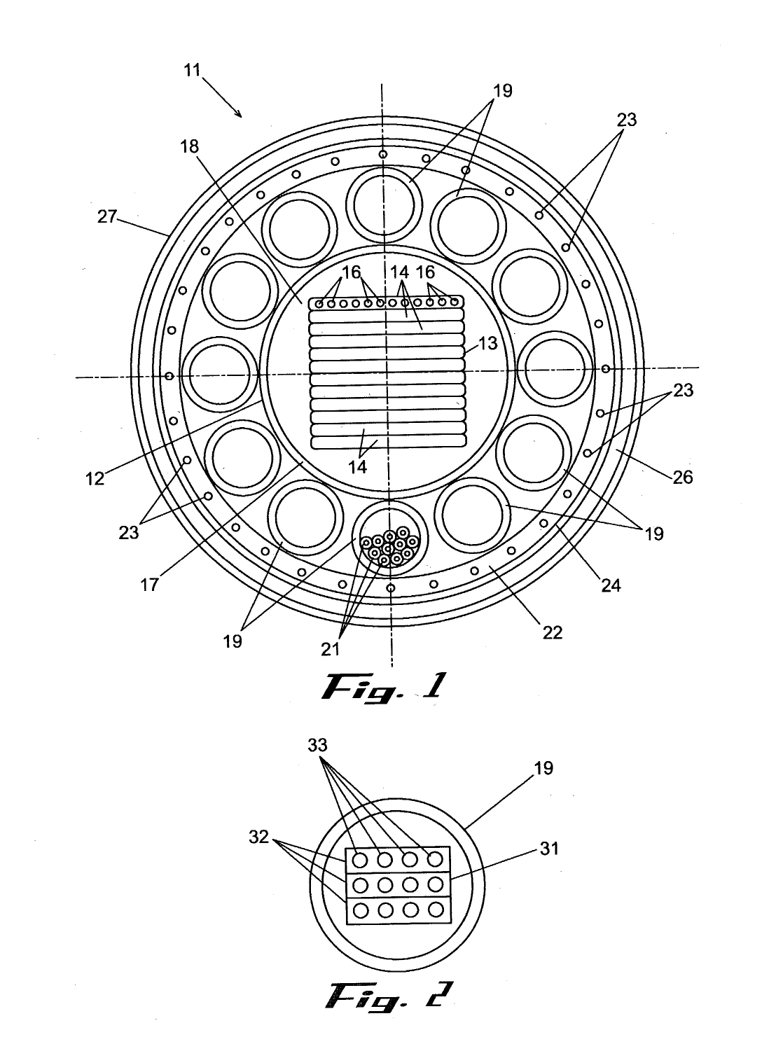

In FIG. 1 there is shown a preferred embodiment of the invention which comprises a hybrid cable 11 having a central core member 12 in which a ribbon stack 13 of, for example, twelve ribbons 14, each having twelve fibers 16, is enclosed in an inner tube member 17. The empty space within tube member 17 is preferably filled with a suitable waterproofing material or gel 18, such as, for example, the low yield stress thixotropic material disclosed in the aforementioned Eichenbaum, et al. patent. Tube member 17, which forms an inner jacket around the stack 13 and gel 18 may be made of any of a number of suitable materials, such as polyethylene. For simplicity, only one of the ribbons 14 is shown with the fibers 16, it being understood that each of the twelve ribbons 14 contains its complement of twelve substantially parallel fibers 16 encased in a suitable matrix material.

Surrounding tube member 17 are twelve lose tubes 19, each of which contains twelve loosely grouped fibers 21 which are preferably buffered with a suitable buffering material. Only one of the tubes 19 is shown containing fibers, but it is to be understood that each of the tubes 19 contains its complement of twelve fibers 21. Surrounding the circular array of tubes 19 is a protective sheath 22 of, for example, high density polyethylene which may, for example, have embedded therein strength members 23 of aramid fiber, glass roving, or wire. Protective sheath 22 is surrounded by a polyester tape 24 and a second protective sheath 26, which may or may not have strength members embedded therein, surrounds the tape 24. The entire assembly as thus far described is preferably enclosed in a jacket 27.

The cable 11 of FIG. 1 thus is a hybrid structure in the sense that there are both ribbons arranged in a stack 13 for trunk usage, and loose tube fiber tubes 19 for break-out accessibility. The entire cable 11 has approximately the same dimensions, i.e., diameter as prior art cables having one ribbon stack of twenty ribbons, with two hundred and eighty-eight fibers arranged in the stack, and thus the cable of the invention yields considerably greater fiber density. A prior art cable having 288 fibers would require, for example, two twelve ribbon stacks, contained in a much larger diameter structure. It is to be understood that the arrangement of protective tubes may contain more or less tubes, fewer such tubes yielding a smaller diameter cable.

In FIG. 2 there is shown a variation of the loose tube arrangement of FIG. 1 wherein each of the tubes 19 has a stack 31 of three ribbons 32 of four fibers 33 each. With the smaller ribbons 32 and consequent fewer fibers 33, break-out is relatively easily performed while the fibers 33 have a greater protection against possible damage, being segregated from each other.

In FIG. 3 there is shown a hybrid cable 36 embodying the principles of the present invention in which there are three large tubes or sheaths 37, each containing, for example, a twelve ribbon stack 38 containing one hundred and forty-four fibers. For simplicity the units 37 are shown enclosed only in a first outer layer 39 which may comprise several layers such as are shown in FIG. 1. In addition, only one of the sheaths 37 is shown with a ribbon stack 38 therein, but it is to be understood that each of the tubes or sheaths contains a ribbon stack 38. As thus far described, the cable 36 is basically similar to prior art cables containing three ribbons tacks 38 for a total of four hundred and thirty-two fibers, and is of substantially the same outer diameter, including any additional protective layers as shown in FIG. 1 and which are common to prior art cables also.

In accordance with the present invention, three tubular members 39 are interspersed within the cable 36 in the interstices 41 formed by the triangular arrangement of the larger tubes 37. As shown in FIG. 3, each of tubes 39 has, in a loose tube configuration, thirty-six fibers 42 for a total of one hundred and eight fibers, and the cable 36, although of substantially the same diameter as prior art cables having three one hundred forty-four fiber stacks, or a total of four hundred thirty-two fibers. Thus, for the same dimension cable 36, which has five hundred and forty fibers, there is a fiber density improvement of approximately twenty-five percent (25%). In addition, one hundred and eight fibers are, in the loose tube configuration, amenable to simplified break-out, as discussed hereinbefore. Instead of a loose tube configuration, as shown in FIG. 3, it is also feasible to have each of the tubes 39 contain ribbon stacks of thirty-six fibers, in the manner shown in FIG. 2, which would still afford a simplified break-out.

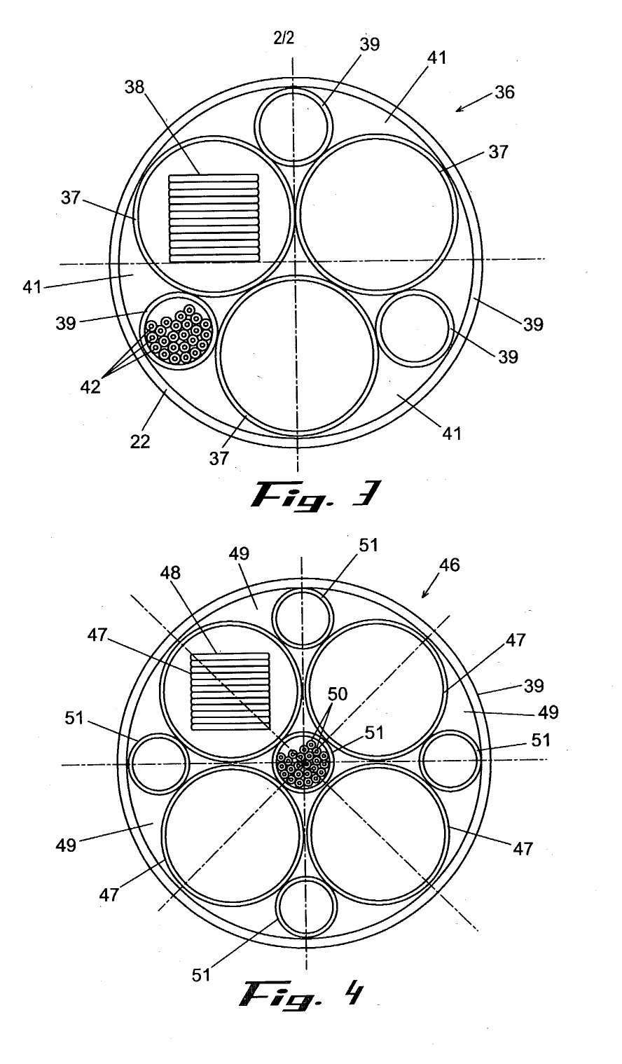

FIG. 4 depicts a cable 46 having four large tubes 47 each containing, for example, a twelve ribbon stack 48 of one hundred forty-four fibers (not shown) for a total fiber count of five hundred and seventy-six fibers. Such an arrangement can be found in the prior art. In accordance with the principles of the invention, there are interspersed within the interstices 49 within the cable, five tubes 51, each containing in a loose tube configuration, twenty-four fibers 50 for a total of one hundred and twenty fibers, giving cable 46 a total of six hundred and ninety-six fibers, a twenty-one percent (21%) improvement in fiber density within the same dimension cable as one containing five hundred and seventy-six fibers in four fiber stacks. As with cable 36 of FIG. 3, instead of a loose tube configuration as shown in FIG. 4, the tubes 51 may contain small fiber stacks of twenty-four fibers 50 each, without materially increasing the difficulty of break-out.

The principles of the invention have been demonstrated in the foregoing embodiments. Such features as increased fiber density without increase in the external dimensions of the cable, and having both easily broken out fibers for local use and fiber stacks for trunk use represent a material improvement over prior art cable. These principles can be extended to apply to even larger cables having different fiber counts within the tubular members without departure from the basic principles set forth.

It is to be understood that the various features of the present invention might be incorporated into other types of cables, and that other modifications or adaptations might occur to workers in the art. All such variations and modifications are intended to be included herein as being within the scope of the present invention as set forth. Further, in the claims hereinafter, the corresponding structures, materials, acts, and equivalents of all means or step-plus-function elements are intended to include any structure, material, or acts for performing the functions in combination with other elements as specifically claimed.

1. A hybrid optical fiber cable comprising:
at least a first tubular sheath member having a first diameter containing an optical fiber ribbon stack having a first member of optical fibers contained therein;
at least one second tubular sheath member having a second diameter less than said first diameter and containing a second number of optical fibers therein less than said first member; and
a third tubular sheath member encloses said first and second tubular sheath members.

2. A hybrid optical fiber cable as claimed in claim 1 wherein said second member of fibers are loosely supported in said second tubular sheath in a loose tube configuration

3. A hybrid optical fiber cable as claimed in claim 2 wherein said third tubular sheath member contains a single first tubular sheath member; and
a plurality of a second sheath members each in a loose tube fiber containing configuration surrounds said first tubular sheath member.

4. A hybrid optical fiber cable as claimed in claim 3 wherein the total member of fibers contained in said plurality of second sheath members is equal to the total number of fibers in said optical fiber ribbon stack in said first tubular sheath.

5. A hybrid optical fiber cable as claimed in claim 4 wherein said optical fiber ribbon stack contains one hundred and forty-four optical fibers and said plurality of second sheath members contains one hundred and forty-for optical fibers.

6. A hybrid optical fiber cable as claimed in claim 4 wherein there are twelve second sheath members surrounding said first sheath member, and each second sheath member contains twelve optical fibers in a loose tube configuration.

7. A hybrid optical fiber cable as claimed in claim 2 wherein said first sheath member is, in addition to said optical fiber stack, filled with a water blocking material.

8. A hybrid optical fiber cable as claimed in claim 7 wherein said second sheath member is, in addition to said optical fiber therein, filled with a water blocking material.

9. A hybrid optical fiber cable as claimed in claim 2 wherein said third tubular sheath member contains at least three first tubular sheath members, each containing at least one optical fiber ribbon stack wherein interstices are created within the space enclosed by said third tubular sheath; and
a plurality of second fiber containing tubular sheaths located in said interstices.

10. A hybrid optical fiber cable as claimed in claim 9 wherein there are three fiber stack containing first sheath members within said third sheath and three fiber containing second sheath members within said interstices.

11. A hybrid optical fiber cable as claimed in claim 10 wherein there are four hundred and thirty-two fibers contained in said three first sheath members.

12. A hybrid cable as claimed in claim 11 wherein there is a total of one hundred and eight fibers in said second sheath members for a total fiber count of five hundred and forty.

13. A hybrid optical fiber cable as claimed in claim 9 wherein there are four fiber stack containing first sheath members within said third sheath and five fiber containing second sheath members within said interstices.

14. A hybrid optical fiber cable as claimed in claim 13 wherein there are five hundred and seventy-six fibers contained in said first sheath member.

15. A hybrid optical fiber cable as claimed in claim 14 wherein there is a total of one hundred and twenty fibers in said second sheath members for a total fiber count of six hundred and ninety-six.

16. A hybrid optical fiber cable as claimed in claim 1 wherein said third tubular sheath member has strength members embedded therein.
